(19) United States
(12) Patent Application Publication
(10) Pub. No.: US 2024/0421945 A1
(43) Pub. Date: Dec. 19, 2024

(54) SYSTEM AND METHOD FOR RELAYING IN WIRELESS COMMUNICATIONS

(71) Applicant: Samsung Electronics Co., Ltd., Suwon-si (KR)

(72) Inventors: Yaser Mohamed Mostafa Kamal FOUAD, San Diego, CA (US); Philippe Jean Marc Michel SARTORI, Naperville, IL (US)

(21) Appl. No.: 18/744,562

(22) Filed: Jun. 14, 2024

Related U.S. Application Data
(60) Provisional application No. 63/521,549, filed on Jun. 16, 2023.

(51) Int. Cl. H04L 1/1867; H04L 5/00; H04W 88/04

(52) U.S. Cl. CPC H04L 1/1896; H04L 5/0055; H04W 88/04

(57) ABSTRACT

A system and a method are disclosed for relaying in wireless communications. In some embodiments, a method includes: receiving, by a first User Equipment (UE), a single first Transport Block including a plurality of Code Block Groups (CBGs); attempting to decode each of the CBGs, by the first UE; and signaling, to a second UE, by the first UE: a successful decoding of a first CBG; and a unsuccessful decoding of a second CBG.

### CROSS-REFERENCE TO RELATED APPLICATION

This application claims the priority benefit under 35 U.S.C. § 119 (e) of U.S. Provisional Application No. 63/521,549, filed on Jun. 16, 2023, the disclosure of which is incorporated by reference in its entirety as if fully set forth herein.

### TECHNICAL FIELD

The disclosure generally relates to wireless communications. More particularly, the subject matter disclosed herein relates to improvements to systems and methods for relaying in wireless communications.

### SUMMARY

In a wireless communication system, the quality of the channel between a source of data (e.g., a network node (gNB)) and a recipient of the data, e.g., a target user equipment (UE), may on occasion be relatively poor (e.g., as a result of obstructions or excessive distance between the source and the recipient), resulting in low reliability.

To solve this problem, a relaying UE, which may be, e.g., between the source and the target UE, may, at the Media Access Control (MAC) layer, relay, or “retransmit” to the target UE a Transport Block (TB) that was not entirely successfully received by the target UE.

One issue with the above approach is that the MAC layer is aware of data only at the TB level, and the MAC layer does not have access to the individual code block groups (CBGs) that form a TB. As such, if any part of a TB was not successfully received, by the target UE and is to be relayed by the relaying UE, an entire TB must be relayed, even if the relaying UE successfully decoded some of the CBGs in the original transmission.

To overcome these issues, systems and methods are described herein for performing relaying at the Physical layer (PHY layer).

The above approaches improve on previous methods because they enable (i) the signaling, by a target UE to a relaying UE, of which CBGs were successfully decoded by the target UE and which CBGs were not successfully decoded, and (ii) the relaying, by the relaying UE, of only the CBGs that were not successfully decoded.

According to an embodiment of the present disclosure, there is provided a method, including: receiving, by a first User Equipment (UE), a single first Transport Block including a plurality of Code Block Groups (CBGs); attempting to decode each of the CBGs, by the first UE; and signaling, to a second UE, by the first UE: a successful decoding of a first CBG; and a unsuccessful decoding of a second CBG.

In some embodiments, the method further includes: receiving, by the first UE, from a third UE, a negative acknowledgement (NACK) for a third CBG transmitted by a source; and relaying the NACK to the source.

In some embodiments: the signaling of the successful decoding of the first CBG includes transmitting a first Zadoff-Chu sequence in a Physical Sidelink Feedback Channel (PSFCH), and the signaling of the unsuccessful decoding of the second CBG includes transmitting a second Zadoff-Chu sequence, different from the first Zadoff-Chu sequence, in the PSFCH.

In some embodiments: the signaling of the successful decoding of the first CBG includes transmitting an indication of successful decoding as part of a payload of a Physical Sidelink Shared Channel (PSSCH), and the signaling of the unsuccessful decoding of the second CBG includes transmitting an indication of unsuccessful decoding as part of a payload of a PSSCH. In some embodiments, the method further includes relaying, by the first UE, to a third UE, a third CBG received from a source and successfully decoded by the first UE, the relaying being based on a parameter selected from the group consisting of: proximity of the third UE to the first UE; received signal strength, at the first UE, from the source; received signal strength, at the first UE, from the third UE; successful decoding of the third CBG, by the first UE; receipt, by the first UE, of a previously relayed copy of the third CBG; a type of the first UE; a power level of a first UE; receipt, by the first UE, of a relaying request from the third UE; a priority of the third CBG; and combinations thereof.

In some embodiments, the relaying, by the first UE, to the third UE, of the third CBG, is based on receipt, by the first UE, of a relaying request from the third UE.

In some embodiments, the relaying request is carried in a Sidelink Control Information (SCI).

In some embodiments, the relaying request is a Zadoff-Chu sequence transmitted in a designated resource of a Physical Sidelink Feedback Channel, the designated resource having been configured through Radio Resource Control signaling from a network node for use to signal a retransmission request.

In some embodiments, the transmission in the designated resource signals that any UE receiving the relaying request is requested to perform relaying.

In some embodiments, the transmission in the designated resource signals that any UE receiving the relaying request, that has a measured signal strength above a threshold strength, is requested to perform relaying.

In some embodiments, the method further includes indicating, by the first UE, to the third UE, that the third CBG is a relayed CBG.

In some embodiments, the indicating includes setting a bit in a Sidelink Control Information (SCI) or in a Media Access Control (MAC) Control Element (CE).

In some embodiments, the indicating includes associating, with the third CBG: a Hybrid Automatic Repeat Request (HARQ) process identifier, a source identifier, and a destination identifier, wherein the HARQ process identifier is a HARQ process identifier associated by the source with a second Transport Block, including the third CBG, the source identifier is an identifier of the source, and the destination identifier is an identifier of the third UE.

In some embodiments, the method further includes signaling, by the first UE, to the source, an acknowledgement (ACK) of a successful receipt and decoding of the third CBG by the first UE.

In some embodiments, the method further includes: relaying, by the first UE, to the source, a negative acknowledgement (NACK) received by the first UE from the third UE, the NACK indicating an unsuccessful attempt, by the third UE, to decode the third CBG, the relayed NACK being sent by the first UE in the same resource as a NACK sent to the source by the third UE; or relaying, by the first UE, to the source, an acknowledgement (ACK) received by the first UE from the third UE, the ACK indicating successful decoding, by the third UE, of a fourth CBG received from the source by the third UE, the relayed ACK being sent by the first UE in the same resource as an ACK sent to the source by the third UE.

According to an embodiment of the present disclosure, there is provided a method, including: receiving, by a first User Equipment (UE), a plurality of Code Block Groups (CBGs) from a source; receiving, by the first UE, from a second UE: an acknowledgement for a first CBG of the CBGs, and a negative acknowledgement for a second CBG of the CBGs;

transmitting, by the first UE, to the second UE, the second CBG; and not transmitting, by the first UE, to the second UE, the first CBG.

In some embodiments, the method further includes relaying the negative acknowledgement to the source.

In some embodiments: the receiving of the acknowledgement includes receiving a first Zadoff-Chu sequence in a Physical Sidelink Feedback Channel (PSFCH), and the receiving of the negative acknowledgement includes receiving a second Zadoff-Chu sequence, different from the first Zadoff-Chu sequence, in a PSFCH.

In some embodiments: the receiving of the acknowledgement includes receiving the acknowledgement as part of a payload of a Physical Sidelink Shared Channel (PSSCH), and the receiving of the negative acknowledgement includes receiving the negative acknowledgement as part of a payload of a PSSCH.

According to an embodiment of the present disclosure, there is provided a method, including: receiving, by a first User Equipment (UE), an acknowledgement (ACK) or a negative acknowledgement (NACK), from a second UE, for a first Transport Block sent to the second UE by a source; relaying, by the first UE, the ACK or the NACK to the source; and relaying, by the first UE, a retransmission of the first Transport Block to the second UE.

In some embodiments, the method further includes: receiving, from the source, by the first UE, a second Transport Block including a Media Access Control (MAC) header; and relaying a portion of the second Transport Block to the second UE without decoding a MAC header of the second Transport Block.

### BRIEF DESCRIPTION OF THE DRAWINGS

In the following section, the aspects of the subject matter disclosed herein will be described with reference to exemplary embodiments illustrated in the figures, in which:

FIG. 1 is a system level diagram of a wireless communications system, according to an embodiment.

FIG. 2A is a system level diagram of a wireless communications system, according to an embodiment.

FIG. 2B is a system level diagram of a wireless communications system, according to an embodiment.

FIG. 3A is a flow chart, according to an embodiment.

FIG. 3B is a flow chart, according to an embodiment.

FIG. 3C is a flow chart, according to an embodiment.

FIG. 3D is a flow chart, according to an embodiment.

FIG. 4 is a block diagram of an electronic device in a network environment, according to an embodiment.

FIG. 5 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “or” should be interpreted as “and/or”, such that, for example, “A or B” means any one of “A” or “B” or “A and B”.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein “configured” means pre-configured to a UE by a gNB using Radio Resource Control RRC signaling. As used herein “standard-specified” means specified in a standard (e.g., in a release of the fifth generation (5G) standard promulgated by the 3rd Generation Partnership Project (3GPP)). As used herein, “a portion of” something means “at least some of” the thing, and as such may mean less than all of, or all of, the thing. As such, “a portion of” a thing includes the entire thing as a special case, i.e., the entire thing is an example of a portion of the thing.

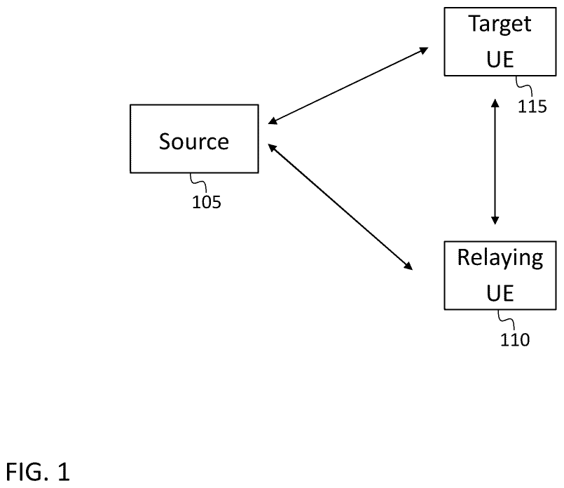

FIG. 1 shows a system including a source 105, a relaying UE 110, and a target UE 115. The source 105 may be for example a network node gNB or a source UE (i.e., a third UE). In operation, the source 105 may communicate directly with the target UE 115 or, with the target UE 115 via the relaying UE 110. In some embodiments data is sent by the source 105 to the target UE 115 and also relayed or instead relayed by the relaying UE 110. In some embodiments, acknowledgement feedback, e.g., including acknowledgements (ACKs) or negative acknowledgements (NACKs) (or both), is sent by the target UE 115 directly to the source 105 and, or instead, by the target UE 115 to the source 105 via the relaying UE 110. As used herein, “relaying”, when used as a verb, means transmitting (e.g., retransmitting), by a transceiver (e.g., by a UE or a gNB) a transmission previously received, e.g., from a UE or a gNB.

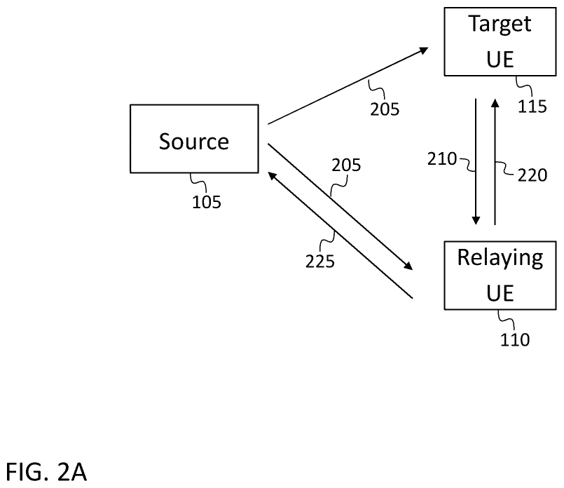

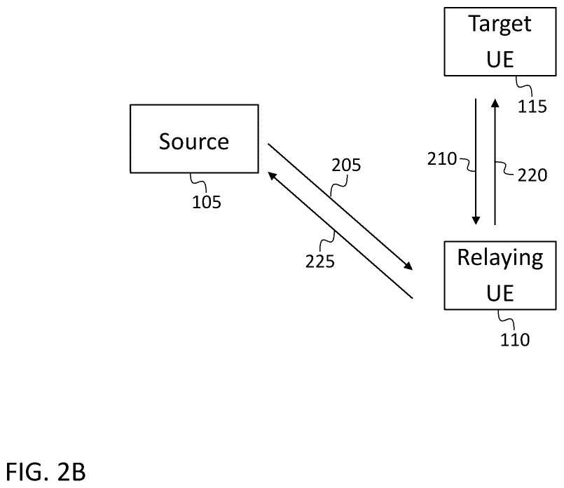

FIG. 2A shows a use case in which transmissions are made between each pair of the three entities: the source 105, the relaying UE 110, and the target UE 115. For example, the source 105 may initially transmit data (e.g., a Transport Block (TB)) to the relaying UE 110 and to the target UE 115, in an initial transmission 205. The TB may be sent in a single set of resources (e.g., resource elements (REs)) received by both the target UE 115 and the relaying UE 110, or in different resources (e.g., sent to the target UE 115 in a first set of resources and to the relaying UE 110 in a second set of resources); in either case the source 105 may have scheduled the transmission of the TB, and notified the relaying UE 110 that it is receiving the data for possible relaying, in advance. When the target UE 115 receives the TB it attempts to decode each code group block (CBG) in the TB, and it then transmits a feedback transmission 210 containing zero or more acknowledgements and zero or more negative acknowledgments. The feedback transmission 210 may be received by the source 105 or by the relaying UE 110 or by both (in the example of FIG. 2A, the feedback transmission 210 is received by the relaying UE 110). In some circumstances, the relaying UE 110 may be better able than the target UE 115 to receive the TB, or the relaying UE 110 may be better able than the target UE 115 to transmit the feedback transmission to the source 105. As such, the relaying UE 110 may be capable of improving the reliability of communications between the source 105 and the target UE 115 by relaying feedback transmissions or CBGs or both. For example, as illustrated in FIG. 2A, the relaying UE 110 may, after receiving the target UE feedback transmission 210, perform a retransmission 220 (which may be referred to as an “opportunistic retransmission”) of the data or relay the feedback transmission 210 to the source 105 in a relayed transmission 225 (which may cause the source to retransmit the TB or the CBGs that were not successfully decoded).

The source 105 (e.g., a gNB) may transmit control signals on a Physical Downlink Control Channel (PDCCH) to schedule resources to be used for (i) transmitting the data (e.g., the CBGs) to the target UE 115 and for (ii) a Physical Uplink Control Channel (PUCCH) for transmitting feedback to the source 105. A single set of resources may be scheduled for a single PUCCH, or two sets of resources may be scheduled for (i) a PUCCH to be transmitted by the target UE 115, and (ii) a PUCCH to be transmitted by the relaying UE 110, respectively.

If the target UE 115 did not successfully decode the entire TB, then it may signal, to the source 105 or to the relaying UE 110, the unsuccessful decoding of one or more CBGs (or the successful decoding of any CBGs that were successfully decoded). The signaling to the source 105 may be performed using the scheduled PUCCH if the source 105 is a gNB. The signaling to the relaying UE 110 (and to the source 105, if the source 105 is a UE) may be performed (i) using the Physical Sidelink Feedback Channel (PSFCH) (e.g., by transmitting a first Zadoff-Chu sequence (ZC sequence) for each successfully decoded CBG and a second Zadoff-Chu sequence for each unsuccessfully decoded CBG) or (ii) by transmitting an indication of successful coding or decoding as part of the payload of the Physical Sidelink Shared Channel (PSSCH) (e.g., by including in the payload a sequence of bits each indicating whether a respective CBG was successfully decoded). In some embodiments, a different type of sequence (e.g., a constant amplitude zero autocorrelation sequence that is not a Zadoff-Chu sequence) is used instead of the first Zadoff-Chu sequence or instead of the second Zadoff-Chu sequence.

When the target UE 115 signals to the relaying UE 110 the unsuccessful decoding of one or more CBGs, the relaying UE 110 may send it the CBGs it failed to decode. This may occur in different ways, after the relaying UE 110 receives a NACK for each of one or more CBGs. For example, the relaying UE 110 may determine that it was able to decode the CBGs, and take over communication with the target UE 115 by (i) sending an ACK for all of the CBGs to the source 105, and (ii) relaying the CBGs to the target UE 115. In another embodiment, the relaying UE 110 forwards the one or more NACKs to the source 105, which then re-transmits the CBGs to the target UE 115.

FIG. 2B shows a set of transmissions that may occur, in some embodiments. In the example of FIG. 2B, the source 105 may initially transmit data (e.g., a Transport Block (TB)) to the relaying UE 110 (and not to the target UE 115), in an initial transmission 205. The source 105 may have scheduled the transmission of the TB, and notified the relaying UE 110 that it is receiving the data for possible relaying, in advance. The relaying UE 110 may perform a retransmission 220 of the data. The target UE 115 may then send a feedback transmission to the relaying UE 110.

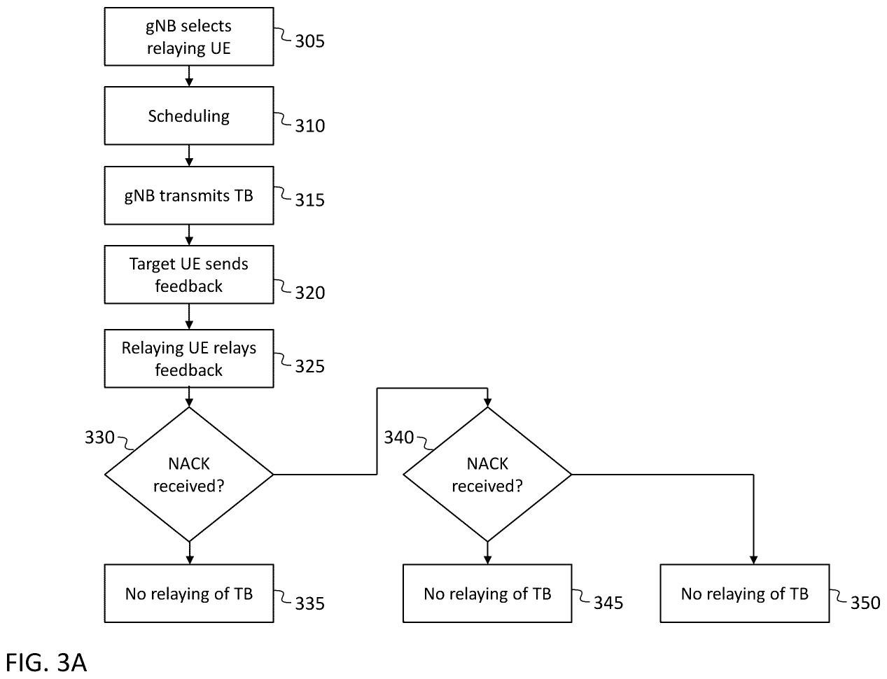

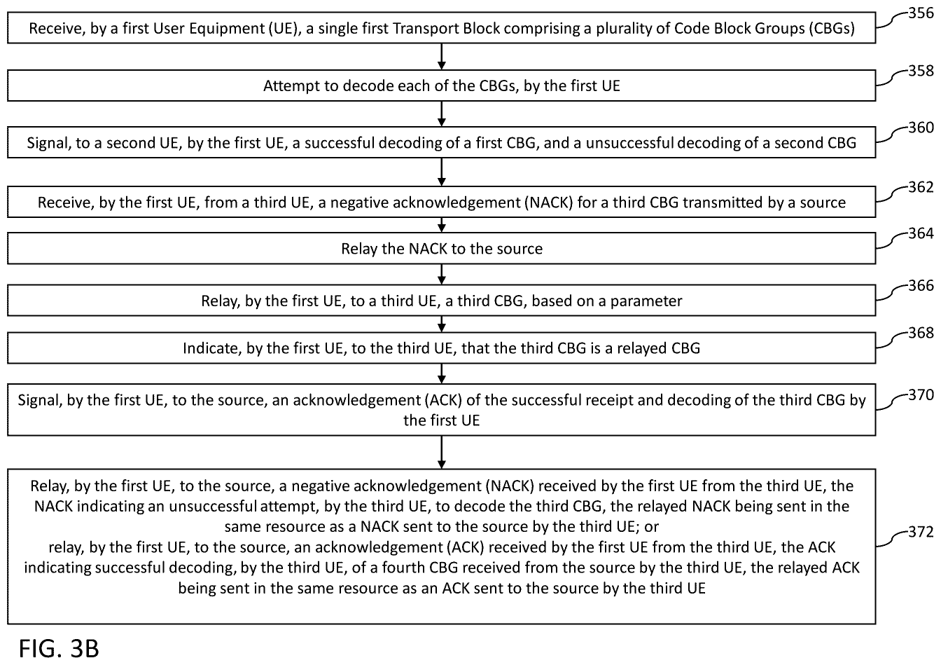

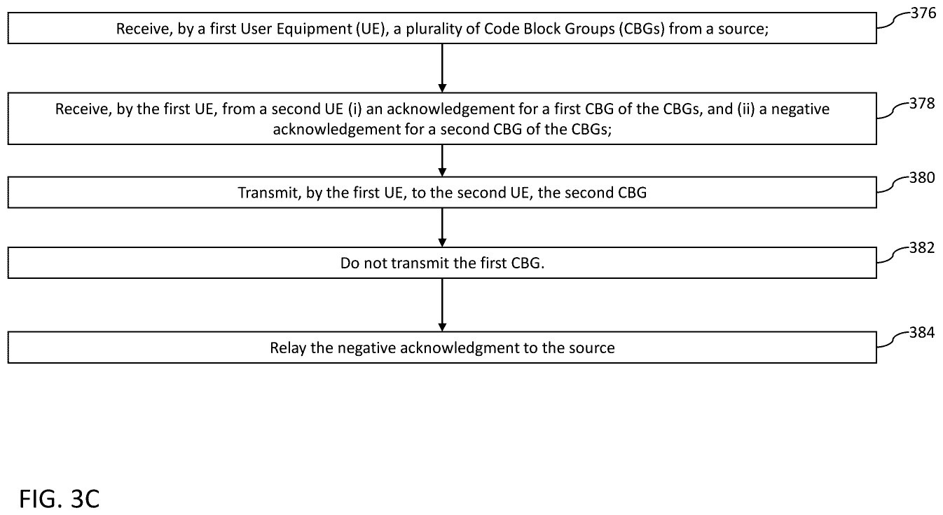

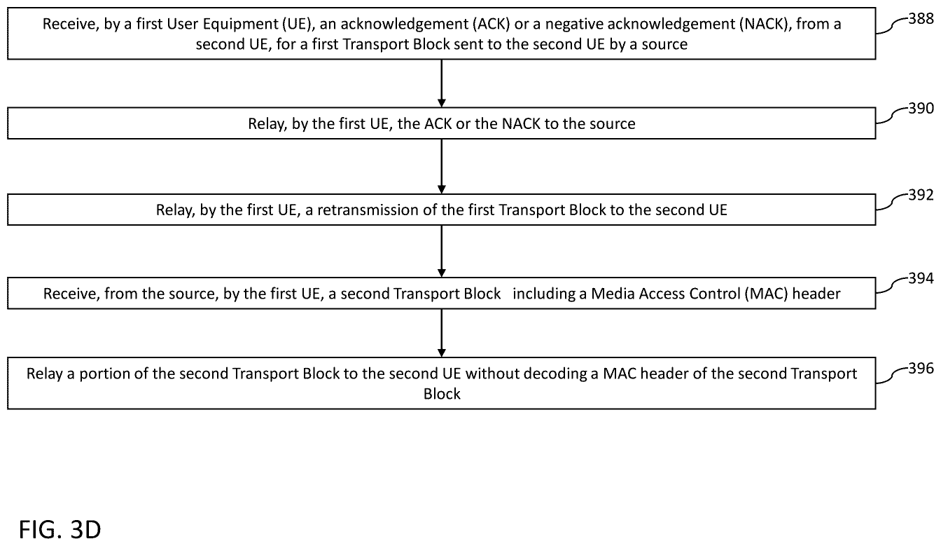

FIG. 3A is a flow chart showing an example of the transmissions between a source 105 (a gNB in the example of FIG. 3A), a relaying UE 110 and a target UE 115. At 305, the gNB selects a UE to act as the relaying UE 110 to the target UE 115; at 310, the gNB sends a

PDCCH with a Downlink Control Information (DCI) to schedule a Physical Downlink Shared Channel (PDSCH) and two corresponding PUCCH transmissions (a first PUCCH and a second PUCCH) for feedback (e.g., for zero or more acknowledgements (ACKs) and zero or more negative acknowledgements (NACKs)). If the source 105 is a UE, then one or more Sidelink Control Informations (SCIs) may be used for the scheduling of feedback transmissions by the relaying UE 110. At 315, the gNB sends a PDSCH with data, e.g., with a TB. At 320, the target UE 115 sends its feedback to the gNB in the first PUCCH transmission, or (as shown) to the relaying UE 110 in a PSFCH, or both (one or both of which may have been scheduled by the DCI). If the source 105 is a UE then the target UE feedback may be sent to the source 105 on a PSFCH which may also be received by the relaying UE 110. If the target UE feedback is transmitted to the relaying UE 110 in a PSFCH, the resources for this PSFCH may be related to the resources scheduled for the transmission of the PDSCH (e.g., by a configured or standard-specified one-to-one mapping); as such, a single DCI transmitted by a gNB may be used to schedule both the PDSCH and the PSFCH used to transmit the target UE feedback to the relaying UE 110. The PSFCH resources may be selected from a reserved pool of resources not used for feedback for (non-relayed) transmissions between UEs, to avoid collisions. When the target UE 115 sends the feedback to the relaying UE 110, it may also send to the relaying UE 110 a request for the relaying UE 110 to relay the feedback of the target UE 115 to the source 105. At 325, the relaying UE 110 forwards the feedback received from the target UE 115 to the gNB in the second PUCCH. The DCI may include an indication that the second PUCCH is to be used by the relaying UE 110 for relaying of feedback from the target UE 115. If the source 105 is a UE, then the feedback may be transmitted to the source 105 in one or more PSFCHs. In embodiments in which the target UE feedback is transmitted to the source 105 twice (e.g., once by the target UE 115 and once by the relaying UE 110), the source 105 may have two opportunities to receive it, and it may use the later-transmitted target UE feedback if the earlier-transmitted target UE feedback is not received.

At 330, if the relaying UE 110 does not receive any NACKs from the target UE 115, then, at 335, it does not relay any of the CBGs of the TB, and it discards any successfully received and decoded CBGs. If the relaying UE 110 does receive one or more NACKs from the target UE 115, then, at 340, if the relaying UE 110 has received and successfully decoded any CBGs for which the target UE 115 sent a NACK, the relaying UE 110 performs, at 345, a sidelink relay transmission, to the target UE 115, carrying one or more of these CBGs; otherwise, at 350, the relaying UE 110 does not relay any of the CBGs of the TB, and it discards any successfully received and decoded CBGs. If the source 105 is a UE, then the CBGs may be transmitted on a PSSCH (and control information associated with the PSSCH may be transmitted on a PSCCH) and the PSSCH and the PSCCH may be associated with either (i) two PSFCH resources for feedback (sent to the source 105 and the relaying UE 110, respectively) or with (ii) one PSFCH resource that may be received by one or both of the source UE and the relaying UE 110.

The signaling of the target UE 115 requesting relaying of the target UE feedback may be performed using inter-UE signaling (discussed in further detail below), e.g., (i) using a bit (e.g., a new field) of the first or second stage sidelink control information (SCI) or using a Media Access Control (MAC) Control Element (CE), or (ii) using implicit signaling (by setting one or more fields of the DCI to predefined values), or (iii) using a predefined offset of the PSFCH resources when sending the feedback (for example, the target UE 115 may signal a request to relay the target UE feedback by sending the feedback to the relaying UE 110 in a designated resource, which may be one of a plurality of allocated PSFCH resources).

If the PDSCH is sent as a unicast or groupcast Option 2 transmission, then the relaying UE 110 may be able to omit relaying of any NACKs, because an absence of feedback may be interpreted, by the source 105, as a NACK; moreover, if the target UE 115 successfully decoded all of the CBGs, then the likelihood of successful receipt, by the source 105, of the corresponding ACKs sent by the target UE 115, may be high because differences in the encoding of the data and the feedback may favor successful reception of the feedback transmission. If the PDSCH is sent as a groupcast Option 1 transmission, then relaying of any NACKs sent by the target UE 115 may be advantageous because the source 105 may interpret the absence of a received NACK as an ACK. Relaying of feedback by the relaying UE 110 may be advantageous in circumstances in which collisions between feedback transmitted by several UEs are likely.

In some embodiments, the relaying UE 110 may, instead of relaying the feedback it receives from the target UE 115, send, in the second PUCCH, feedback of the relaying UE 110, e.g., feedback indicating whether it successfully decoded each of the CBGs. In such an embodiment, the relaying UE 110 may then proactively (or in accordance with instructions received (e.g., in the form of a DCI scheduling a sidelink transmission from the relaying UE 110 to the target UE 115 (identified implicitly or, e.g., by the identifier (ID) of the target UE 115), for retransmitting the CBGs) from the source 105) retransmit to the target UE 115 the CBGs not successfully received by the target UE 115. In other embodiments, or in other circumstances, the target UE 115 may first transmit its feedback to the relaying UE 110, which may then relay the feedback to the source 105 in the same resources as the resources scheduled for the transmitting, by the target UE 115, of the PUCCH containing the feedback from the target UE 115. In some such embodiments both the target UE 115 and relaying UE 110 transmit the same feedback in the same resources, and the signal from the UE (of the target UE 115 and the relaying UE 110) with the stronger signal may then be received by the source 105 (e.g., by the gNB).

The source 105 (e.g., the gNB) and the relaying UE 110 may be configured to accommodate various feedback time delays that may be greater than in the absence of relaying. For example, delay may be incurred as a result of (i) the target UE 115 transmitting the feedback to the relaying UE 110 after transmitting the feedback to the source 105 (unless the target UE 115 transmits its feedback first to the relaying UE 110 and then to the source 105), and (ii) the relaying UE 110 decoding and retransmitting the feedback. For example, if the source 105 schedules two PUCCHs as described above, the two PUCCHs may be sufficiently separated in time to accommodate these delays. Similarly, if the source 105 is a UE, two PSFCH occasions may be used to transmit the target UE feedback (i) by the target UE 115, and (ii) by the relaying UE 110 (after receipt of the feedback from the target UE 115 by the relaying UE 110).

In some embodiments, the relaying UE 110 determines whether to relay the target UE feedback to the source 105 (e.g., without relying on a relaying request from the target UE 115), e.g., forwarding the target UE feedback if and only if the signal quality of the signals on the PSFCH channel are below a threshold (e.g., a configured threshold).

In some embodiments, one or more UEs may each be selected to operate as a relaying UE 110, using any of a plurality of criteria, each of which may be based on one or more parameters (e.g., the relaying may be performed in response to the parameter or parameters, or in response to values of the parameter or parameters). This may be advantageous in circumstances in which (i) more than one UE is capable of operating as the relaying UE 110 but only one relaying UE 110 is desired, or (ii) sufficiently many UEs are capable of operating as relaying UEs 110 that such operation by all of them would result in degraded performance (e.g., as a result of collisions).

In some embodiments, proximity of the UE to the target UE 115 is used as a parameter to determine whether the UE will operate as a relaying UE 110. For example, the UE may be selected if the distance to the target UE 115 is less than a threshold distance. The distance may be determined (i) from locations exchanged through basic safety messages, (ii) from the received signal strength of signals transmitted between the UE and the target UE 115 (e.g., from the Received Signal Strength Indicator (RSSI) or the Reference Signal Received Power (RSRP), measured, e.g., on the feedback channel from the target UE 115, or on the DMRS signals embedded in the PSCCH of the sidelink transmission), or (iii) from the zone ID of the UE and the target UE 115 (e.g., whether the UE and the target UE 115 are in the same zone). The threshold distance may be configured (e.g., per resource pool) or standard-specified, or dynamically indicated to the UE by the target UE 115. In some embodiments, the parameter used to determine whether the UE will operate as a relaying UE 110 is the signal strength instead of (or in addition to) the proximity.

In some embodiments, received signal strength, at the UE, from the source 105 (e.g., the signal strength of signals received by the UE from the source 105) is used as a parameter to determine whether the UE will operate as a relaying UE 110. The received signal strength may be measured or estimated based on a measured RSSI or RSRP, e.g., (i) the RSRP of a DMRS signal (e.g., a DMRS signal embedded in a Synchronization Signal Block (SSB) or a DMRS signal embedded in a PSBCH), or (ii) RSSI measurements performed on subchannels (e.g., for Channel Busy Ratio (CBR) calculations). A criterion corresponding to this parameter may be that the signal strength must be below a threshold signal level (which may be configured, or standard-specified, or dynamically indicated to the UE by the target UE 115) for the UE to operate as a relaying UE 110 (because if the UE is very close to the source 105, it is unlikely to be better able to transmit to, or receive from, the target UE 115 than the source 105 is).

In some embodiments, successful decoding of one or more CBGs needed by the target UE 115 is used as a parameter to determine whether the UE will operate as a relaying UE 110. For example, a UE may operate as a relaying UE 110 only if it successfully decoded the entire TB one or more CBGs of which are to be relayed, or if it successfully decoded all of the CBGs to be relayed, or if it successfully decoded at least one of the CBGs to be relayed.

In some embodiments, receipt, by the UE, of a previously relayed copy of one or more CBGs needed by the target UE 115 is used as a parameter to determine whether the UE will operate as a relaying UE 110. For example, a UE that has received a previously relayed copy of one or more CBGs needed by the target UE 115 may refrain from operating as a relaying UE 110, or it may refrain if it received the relayed copy with a signal strength exceeding a threshold. The ability to refrain from operating as a relaying UE 110 may be greater when the previously relayed copy was sent far enough in advance, of the relaying transmission the UE would make if operating as a relaying UE 110, for the UE to process the previously relayed copy beforehand.

In some embodiments, a type of the UE is used as a parameter to determine whether the UE will operate as a relaying UE 110. For example, a vehicle UE or a road side unit may be more capable than a pedestrian UE; in some circumstances relaying UEs 110 may therefore be limited to such (more capable) UEs.

In some embodiments, a power level (e.g., a transmitting power capability) of the UE is used as a parameter to determine whether the UE will operate as a relaying UE 110. As such, a UE with a high power level (e.g., a high transmitting power capability) may be more capable than a pedestrian UE; in some circumstances relaying UEs 110 may therefore be limited to such (more capable) UEs.

In embodiments in which UE capability (e.g., UE type or UE power level) is a parameter used in a criterion to select a relaying UE 110, a lower capability UE may not be prevented from operating as a relaying UE 110 but instead may be required to wait during a delay interval (which may be configured, or standard-specified, or dynamically indicated to the UE by the target UE 115) before beginning operation as a relaying UE 110. In such an embodiment, if a more capable UE is present and begins operation as a relaying UE 110 before the less capable UE, the less capable UE may receive a previously relayed copy of one or more CBGs needed by the target UE 115 and, in response, refrain from operating as a relaying UE 110.

In some embodiments, receipt, by the UE of a relaying request from the target UE 115 is used as a parameter to determine whether the UE will operate as a relaying UE 110. Such a relaying request (and any criteria for selection of relaying UEs 110 from among the UEs receiving the request) may be transmitted using any of several implicit or explicit signaling methods referred to herein as “inter-UE signaling” and discussed in further detail below. The request may be (i) unicast (to a UE the ID of which is included in the request) or (ii) broadcast to all UEs receiving the request, or (iii) groupcast to a set of UEs that have received the request and that meet one or more other criteria (e.g., that their distances from the target UE 115 are less than a threshold distance) (the additional criteria may also be signaled using inter-UE signaling). The relaying request may be sent in the PSFCH channel (and the inter-UE signaling may be implicit PSFCH resource signaling). The relaying request may expire after a certain duration (which may be configured, or standard-specified, or dynamically indicated to the UE by the target UE 115) (to accommodate network dynamics) or it may be cancelable by the target UE 115 (via inter-UE signaling). The UE ID used to identify a particular UE (e.g., as a UE being requested to operate as a relaying UE 110) may be a Physical layer (PHY layer) ID or a higher layer ID (which may be different from the PHY layer UE).

In some embodiments, a priority of the one or more CBGs to be relayed (e.g., a priority of the TB including the one or more CBGs) is used as a parameter to determine whether the UE will operate as a relaying UE 110. For example, the UE may operate as a relaying UE 110 and relay the CBGs only if the priority exceeds a threshold (which may be configured per resource pool, or standard-specified, or dynamically indicated to the UE by the target UE 115). As another example, the UE may operate as a relaying UE 110 and relay the CBGs only if the packet delay budget is less than a threshold (which may be configured per resource pool, or standard-specified, or dynamically indicated to the UE by the target UE 115).

In some embodiments, combinations of these parameters may be used to determine whether the UE will operate as a relaying UE 110. For example, proximity of the UE to the target UE 115, or the received signal strength of signals transmitted between the UE and the target UE 115 (e.g., a measured RSSI or a measured RSRP of a signal received by the UE from the target UE 115), may be used in combination with signal strength received by UE from the source 105 (e.g., the UE may be selected only if either threshold criterion is met, or only if both threshold criteria are met). As another example, a target UE 115 may issue a conditional relaying request, requesting that each UE that (i) receives the request and (ii) meets one or more other criteria (e.g., a criterion based on proximity to the target UE 115 and the criterion that the UE have successfully decoded all of the CBGs the target UE 115 needs) operate as a relaying UE 110. In some circumstances the selection of a relaying UE 110 (e.g., the determination that a UE will operate as a relaying UE 110) may be separate from the decision whether to relay one or more CBGs; this relaying may, for example, be separately triggered (e.g., requested) by the target UE 115.

As such, in some embodiments, a method includes relaying, by a first UE (e.g., a relaying UE 110), to a third UE (e.g., a target UE 115), a CBG received from a source 105 and successfully decoded by the first UE, the relaying being based on a parameter selected from the group consisting of: proximity of the third UE to the first UE; received signal strength, at the first UE, from the source; received signal strength, at the first UE, from the third UE; successful decoding of the third CBG, by the first UE; receipt, by the first UE, of a previously relayed copy of the third CBG; a type of the first UE; a power level of a first UE; receipt, by the first UE, of a relaying request from the third UE; priority of the third CBG; and combinations thereof.

The sending of a relaying request by a target UE 115 may be performed in several different ways, e.g., (i) by an explicit request from the target UE 115, (ii) as a result of a proactive determination by the relaying UE 110, based on the quality of the link from the target UE 115, or (iii) as a result of a proactive determination by the relaying UE 110, based on the quality of the link with the source 105.

An explicit request from the target UE 115 may include (e.g., consist of) feedback (e.g., an ACK or a NACK) sent on the PSFCH channel, as discussed above in the context of FIG. 3A. When the relaying UE 110 receives feedback indicating that one or more CBGs were not successfully decoded by the target UE 115, the relaying UE 110 may retransmit those CBGs. Such feedback may be accompanied by a relaying request, transmitted using inter-UE signaling.

A proactive determination made by the relaying UE 110 may involve the relaying UE 110 relaying all of the CBGs of a TB based on the measured link quality of (i) a signal previously received on the PSFCH channel from the target UE 115 or (ii) a signal from the source 105, carrying the TB. Proactive transmissions may have the advantage of reducing latency. In such an embodiment, the relaying UE 110 may proactively relay all of the CBGs if the link quality of either or both signals is below a respective (or common) threshold (which may be configured, or standard-specified, or dynamically indicated to the UE by the target UE 115). In some embodiments, the proactive retransmission may be performed when the link quality of a signal from the source 105 is both less than a first threshold and greater than a second threshold per resource pool; such a restriction may be used to limit the number of relaying UEs to avoid excessively burdening the system with relayed packets.

In some embodiments, the relaying UE 110 performs a number of (proactive) retransmissions (e.g., repetitions of the retransmission of all of the CBGs of the TB); in some such embodiments the number of such repetitions is determined based on the same criteria (discussed above) used to determine whether to perform a proactive retransmission. For example, if the measured link quality of one of the signals discussed above is below a first threshold, the relaying UE 110 may perform a single transmission, and if the link quality of the signal is below a second threshold, lower than the first threshold, the relaying UE 110 may perform two retransmissions (i.e., one repetition after the first retransmission). In other embodiments the number of repetitions may instead (or also) be based on the priority of the CBGs or on the packet delay budget (with, e.g., CBGs with a priority or packet delay budget above a respective threshold (which may be configured, or standard-specified, or dynamically indicated to the UE by the target UE 115) being retransmitted more times).

In some embodiments, multiple UEs may operate as relaying UEs 110 concurrently or simultaneously, e.g., for Ultra Reliable Low Latency Communications (URLLC) traffic. For example, the target UE 115 may request retransmissions from a plurality of relaying UEs 110, e.g., by including a specific groupcast ID in a groupcast relaying request transmission (for requesting retransmission), which may be analogous to groupcast Option 2 in sidelink. The IDs of the relaying UEs 110 of which the request is made may be signaled using inter-UE signaling (with, e.g., implicit PSFCH resource signaling being used with the feedback transmission sent by the target UE 115).

The selection of PSFCH resources from the subset of PSFCH resources available (e.g., from the subset corresponding to an indication to be signaled implicitly using implicit PSFCH resource signaling) may be random or it may be selected based on the resources used to carry the original TB or on the ID of the target UE 115 or on a combination thereof. In some embodiments, the target UE 115 may send two feedback transmissions, one to carry the feedback and one to perform the implicit signaling that requests a retransmission by the relaying UE 110. In some circumstances (e.g., in case of strict latency requirements) the target UE 115 may send a (broadcast) request to all UEs receiving the request that have received the TB (or the CBGs needed by the target UE 115) to perform a retransmission. This request may be sent by inter-UE signaling or by RRC configuration (e.g., in a manner analogous to that of a configured grant type 1 in which the transmission is RRC configured and does not need a DCI to be triggered.

In some embodiments, the target UE 115 specifies, in the request, one or more distance ranges, and the request is understood, by any UE receiving it, to be a request for retransmission if the UE receiving the request is within the applicable range for the request. The range that applies may depend on the priority of the CBGs to be retransmitted. In such an embodiment, higher priority packets may be given a larger set of ranges to improve the reliability of the transmission of such packets. In some embodiments, a set of ranges per resource pool is configured to the UEs that may be performing the retransmissions, and the applicable range is determined by the resource pool within which the request for retransmission is sent. The target UE 115 may transmit its zone ID and the request for retransmission using inter-UE signaling, and any UE that is within the applicable distance of the target UE 115 may then perform a retransmission. The retransmissions of all the relaying UEs 110 may all contain the same TB and these retransmissions may therefore all be associated with the same PSFCH resources for feedback. In some embodiments, the target UE 115 may request retransmission by using a configured PSFCH resource for target UE feedback, the PSFCH resource corresponding to the resources in which the original TB transmission was scheduled.

In some embodiments, the target UE 115 may signal to the relaying UE 110 which CBGs of a TB have been successfully decoded by the target UE 115, or which CBGs of a TB have not been successfully decoded by the target UE 115, or both. For example, a method may include receiving, by a first UE (a target UE 115), a plurality of CBGs; attempting to decode each of the CBGs, by the first UE; and signaling, to a second UE (a relaying UE 110), by the first UE, (i) the successful decoding of a first CBG; and (ii) the unsuccessful decoding of a second CBG. Such signaling may represent an improvement in the technology of wireless communications, because it may avoid the inefficiency of resending an entire TB (as may be done by legacy UEs using MAC layer relaying) when some CBGs have already been successfully received by the target UE 115. The signaling may be accomplished in several ways.

In some embodiments, the target UE 115 transmits a set of Zadoff-Chu sequences (in the one or more PSFCHs), transmitting, e.g., one Zadoff-Chu sequence for each CBG of the TB, and, for each CBG, transmitting either (i) a first Zadoff-Chu sequence to signal that the CBG was successfully decoded by the target UE 115 or (ii) a second Zadoff-Chu sequence to signal that the CBG was not successfully decoded by the target UE 115. In some embodiments, the target UE 115 may use a set of pairs of Zadoff-Chu sequences (a set of pairs which may be configured, or standard-specified, or dynamically indicated to the target UE 115 by the gNB), each pair including one Zadoff-Chu sequence that may be used to signal an ACK and another Zadoff-Chu sequence that may be used to signal a NACK. The target UE 115 may then use as many pairs as there are CBGs in the TB, to signal successful or unsuccessful decoding of each CBG in the TB. In another embodiment, the target UE 115 may use a plurality of (e.g., 2\hat{ }n) Zadoff-Chu sequences, of which it may transmit, e.g., one (in a slot), to signal any one of a plurality of (e.g., 2\hat{ }n) possible ACK/NACK combinations (e.g., if n=4, it may send any one of 16 candidate Zadoff-Chu sequences to signal ACK or NACK for each of 4 CBGs). Such an embodiment may reduce power consumption for the target UE 115.

In some embodiments, a payload of a Physical Sidelink Shared Channel (PSSCH) is used to carry the feedback bits for one or more CBGs. In some embodiments, when the target UE 115 has other data to transmit, it may merge the feedback bits with the other data, in a single PSSCH.

As mentioned above, in some circumstances the relaying UE 110 may determine that it was able to decode the CBGs needed by the target UE 115 (e.g., that the target UE 115 was not able to decode and therefore NACKed), and take over communication with the target UE 115 by (i) sending an ACK (which may be referred to as an “intermediate ACK”) for all of the CBGs (e.g., for all of the CBGs of the TB) to the source 105, and (ii) relaying, to the target UE 115, the CBGs needed by the target UE 115. This may include performing as many retransmissions of some or all of the CBGs as needed (e.g., if the target UE 115, after a retransmission of some CBGs, performed by the relaying UE 110, again responds with one or more NACKs). This mode of operation may be advantageous especially if the rate of successful reception, by the target UE 115, is significantly better for transmissions from the relaying UE 110 than for transmissions from the source 105.

In some embodiments, the relaying UE 110 is permitted to operate in this mode only if one or more of several constraints are satisfied, the constraints including, (i) a link quality constraint (requiring that the link quality between the relaying UE 110 and the target UE 115 be above a configured threshold), (ii) a constraint that the relaying UE 110 have successfully received all of the CBGs that were NACKed by the target UE 115, and (iii) a constraint that the relaying UE 110 was explicitly or implicitly selected by the target UE 115 to (a) perform the relaying of the CBGs that were not successfully decoded by the target UE 115 (and NACKed by the target UE 115) and to (b) forward the intermediate ACKs to the source 105. This selection may be performed using inter-UE signaling (discussed in further detail below). The link quality used in the first constraint described above may be determined by measuring the RSSI or RSRP over the feedback channel that carried the PSFCH with the feedback from the target UE 115 for the originally transmitted TB. The configured threshold that is used to determine whether the first constraint is met may be configured per resource pool.

When a relaying UE 110 retransmits one or more CBGs (e.g., a TB) to a target UE 115, it may be advantageous for the relaying UE 110 (which may be transmitting to the target UE 115 both (i) CBGs generated by the relaying UE 110 and (ii) relayed CBGs) to signal to the target UE 115 that the relayed CBGs are relayed CBGs. This signaling may be performed using inter-UE signaling (discussed in further detail below).

It may also be advantageous for the relaying UE 110 to link any relayed CBGs to the source 105 (e.g., because the target UE 115 may be receiving relayed CBGs from multiple sources 105). In some embodiments, this is accomplished by the relaying UE 110 by using the same source ID, destination ID, and Hybrid Automatic Repeat Request (HARQ) process ID as those used by the source 105 for the original transmission of the TB. This method may be used in combination with inter-UE signaling for indicating that the relayed CBGs are relayed CBGs (as mentioned above). In another embodiment, a new HARQ process ID may be used by the relaying UE 110. This new HARQ process ID may be sent to the relaying UE 110 by the target UE 115 as part of a relaying request sent by the target UE 115.

As mentioned above, inter-UE signaling may be used to convey various kinds of information between the source 105 (if the source 105 is a UE), the relaying UE 110, and the target UE 115. Inter-UE signaling may operate in several different ways. For example, one or more signaling bits may be sent in a new field in a first or second stage SCI or in a new MAC CE. The new field may be a currently reserved bit (which may be redefined in the standard for use in inter-UE signaling), or the SCI may be modified (e.g., an auxiliary SCI (carrying the new field) may be transmitted along with some SCIs). In some embodiments, one or more existing fields may be set to configured values to carry inter-UE signaling information. For example, some possible values of the destination ID field remain reserved, and similarly some possible values of the source ID field remain reserved. As such, it may be possible to use some of these reserved ID values for this indication. Implicit signaling may be performed by, for example, selecting a subset from among a set of available PSFCH resources that are available to make a PSFCH transmission, with the subset being selected based on the information to be signaled via implicit inter-UE signaling (such signaling may be referred to as implicit PSFCH resource signaling). For example, if a first UE is to transmit a value of zero or one to a second UE, it may use resources from a first subset if the value is zero, and resources from a second subset if the value is one. When implicit inter-UE signaling is used, the set of resources used for this signaling may be separate from resources used by the UEs for feedback transmissions, to avoid collisions.

Various embodiments disclosed herein achieve improvements in the technology of wireless communications by, e.g., making it possible for a target UE 115 to signal successful or unsuccessful decoding of each of a plurality of CBGs in a TB, and by making it possible for a relaying UE 110 to relay, to the target UE 115, only the CBGs that were not successfully decoded (instead of relaying the entire TB, as may be done by legacy UEs using MAC-layer relaying).

FIGS. 3B-3D show methods for relaying, in some embodiments. Although FIGS. 3B-3D illustrate various operations in a method for relaying, embodiments according to the present disclosure are not limited thereto. For example, according to some embodiments, methods for relaying may include addition operations or fewer operations, or the order of operations may vary (unless otherwise explicitly stated or implied) without departing from the spirit and scope of embodiments according to the present disclosure.

The method of FIG. 3B includes receiving, at 356, by a first User Equipment (UE), a plurality of Code Block Groups (CBGs), which may all be part of a single Transport Block (TB). For example, as discussed above in the context of FIG. 2A, the source 105 may transmit a TB comprising the CBGs, and the target UE 115 may receive them. The method further includes attempting, at 358, to decode each of the CBGs, by the first UE, e.g., by the target UE 115, in FIG. 2A. The method further includes signaling, at 360, to a second UE, e.g., in FIG. 2A, the relaying UE 110, using a PSFCH, by the first UE: a successful decoding of a first CBG; and a unsuccessful decoding of a second CBG.

The method further includes: receiving, at 362, by the first UE, from a third UE, a negative acknowledgement (NACK) for a third CBG transmitted by a source; and relaying, at 364, the NACK to the source 105. For example, in the context of FIG. 2A, the first UE may operate at some times as a target UE 115 and at other times as a relaying UE 110 (with the third UE being the target UE 115), and the first UE may receive a NACK from the third UE, and relay the NACK to the source 105. In some embodiments: the signaling of the successful decoding of the first CBG includes transmitting a first Zadoff-Chu sequence in a Physical Sidelink Feedback Channel (PSFCH), and the signaling of the unsuccessful decoding of the second CBG includes transmitting a second Zadoff-Chu sequence, different from the first Zadoff-Chu sequence, in the PSFCH. In some embodiments: the signaling of the successful decoding of the first CBG includes transmitting an indication of successful decoding as part of a payload of a Physical Sidelink Shared Channel (PSSCH), and the signaling of the unsuccessful decoding of the second CBG includes transmitting an indication of unsuccessful decoding as part of a payload of a Physical sidelink shared channel (PSSCH).

In some embodiments, the method further includes relaying, at 366, by the first UE, to a third UE, a third CBG received from a source and successfully decoded by the first UE, the relaying being based on a parameter. The parameter may be selected from the group consisting of: proximity of the third UE to the first UE; received signal strength, at the first UE, from the source; received signal strength, at the first UE, from the third UE; successful decoding of the third CBG, by the first UE; receipt, by the first UE, of a previously relayed copy of the third CBG; a type of the first UE; a power level of a first UE; receipt, by the first UE, of a relaying request from the third UE; a priority of the third CBG; and combinations thereof.

In some embodiments, the relaying, by the first UE, to the third UE, of the third CBG, is based on receipt, by the first UE, of a relaying request from the third UE. In some embodiments, the relaying request is carried in a sidelink control information (SCI). In some embodiments, the SCI is a first stage SCI. In some embodiments, the relaying request is a Zadoff-Chu sequence transmitted in a designated resource of a Physical Sidelink Feedback Channel, the designated resource having been configured through Radio Resource Control signaling from a network node for use to signal a retransmission request. In some embodiments, the transmission in the designated resource signals that any UE receiving the request is requested to perform relaying. In some embodiments, the transmission in the designated resource signals that any UE receiving the request, that has a measured signal strength (e.g., a measured RSSI or a measured RSRP), in a transmission received from the third UE, above a threshold strength (or that is within a threshold distance of the third UE), is requested to perform relaying. In some embodiments, the method further includes indicating, at 368, to the third UE, that the third CBG is a relayed CBG. For example, as discussed above, the first UE may be transmitting to the third UE both CBGs generated by the first UE and CBGs relayed to the third UE from the source 105, and it may be advantageous for the third UE to be able to distinguish between the two kinds of CBG.

In some embodiments, the indicating includes setting a bit in a sidelink control information (SCI). In some embodiments, the SCI is a first stage SCI. In some embodiments, the indicating includes setting a bit in a Media Access Control (MAC) Control Element (CE).

In some embodiments, the indicating includes associating, with the third CBG: a Hybrid Automatic Repeat Request (HARQ) process identifier of a Transport Block including the third CBG, a source identifier, and a destination identifier, wherein the HARQ process identifier is a HARQ process identifier associated by the source with a Transport Block including the third CBG, the source identifier is an identifier of the source, and the destination identifier is an identifier of the third UE. In some embodiments, the method further includes signaling, at 370, by the first UE, to the source, an acknowledgement (ACK) of the successful receipt and decoding of the third CBG. In some embodiments, the method further includes signaling, at 372, by the first UE, to the source, a negative acknowledgement (NACK) indicating an unsuccessful attempt, by the third UE, to decode the third CBG, the NACK being sent in the same resource as a NACK sent to the source by the third UE.

The method of FIG. 3C includes: receiving, at 376, by a first User Equipment (UE), a plurality of Code Block Groups (CBGs) from a source; receiving, at 378, by the first UE, from a second UE (i) an acknowledgement for a first CBG of the CBGs, and (ii) a negative acknowledgement for a second CBG of the CBGs; transmitting, at 380, by the first UE, to the second UE, the second CBG; not transmitting, at 382, by the first UE, to the second UE, the first CBG; and relaying, at 384, the negative acknowledgement to source.

In some embodiments, feedback may be generated by the target UE 115 per TB instead of (or in addition to) per CBG, or a TB may not include a plurality of separately encoded CBGs and may instead be sent as a unit (e.g., encoded and decoded as a unit). In such an embodiment, as shown in FIG. 3D, a method may include receiving, at 388, by a relaying UE 110 (e.g., by a first UE), an acknowledgement (ACK) or a negative acknowledgement (NACK), from a target UE 115 (e.g., from a second UE), for a first TB sent to the second UE by the source 105; relaying, at 390, by the relaying UE 110, the ACK or the NACK to the source 105; and relaying, at 392, by the relaying UE 110 (e.g., in response to receipt of a NACK from the target UE 115), a retransmission of the first TB to the second UE. The method may further include: receiving, at 394, from the source 105, by the relaying UE 110, a second TB including a media access control (MAC) header; and relaying, at 396, a portion of the second TB to the target UE 115 without decoding the MAC header of the second Transport Block.

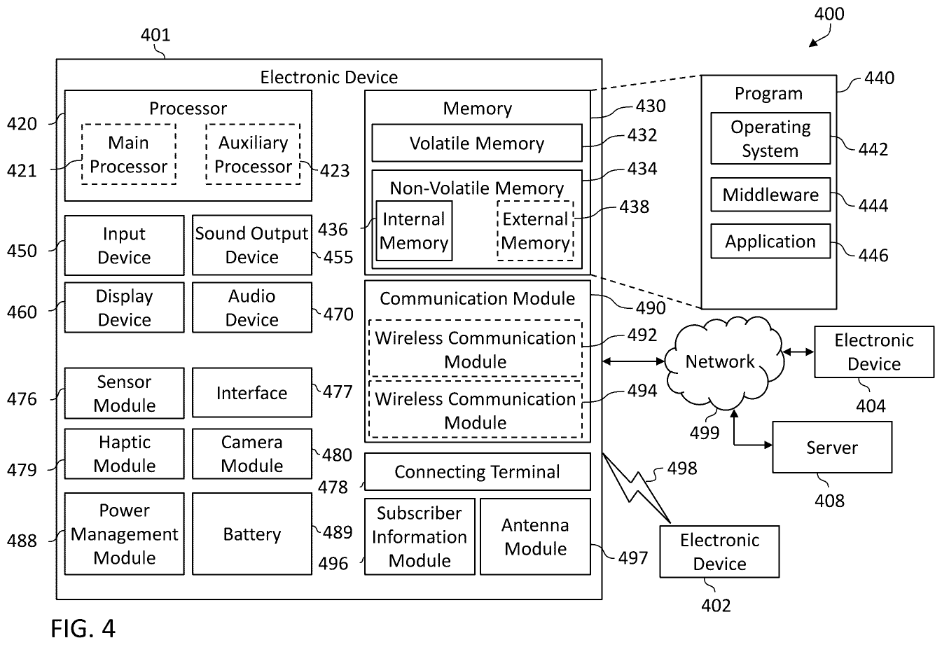

FIG. 4 is a block diagram of an electronic device in a network environment 400, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401.

The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

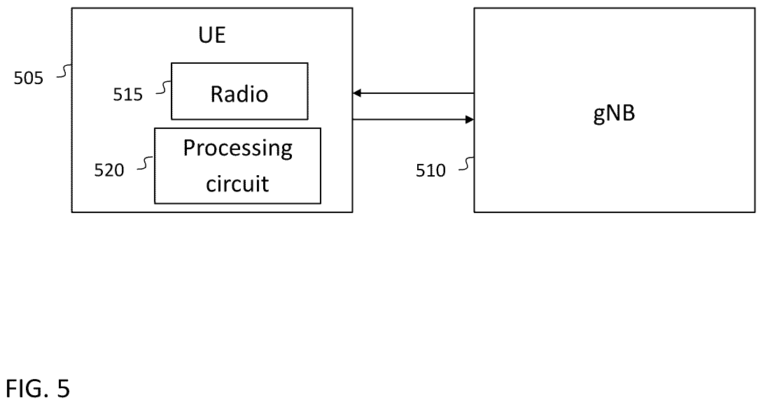

FIG. 5 shows a system including a UE 505 and a gNB 510, in communication with each other. The UE may include a radio 515 and a processing circuit (or a means for processing) 520, which may perform various methods disclosed herein, e.g., the method illustrated in FIG. 3A. For example, the processing circuit 520 may receive, via the radio 515, transmissions from the network node (gNB) 510, and the processing circuit 520 may transmit, via the radio 515, signals to the gNB 510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving, by a first User Equipment (UE), a single first Transport Block comprising a plurality of Code Block Groups (CBGs);
attempting to decode each of the CBGs, by the first UE; and
signaling, to a second UE, by the first UE:
a successful decoding of a first CBG; and
a unsuccessful decoding of a second CBG.

2. The method of claim 1, further comprising:
receiving, by the first UE, from a third UE, a negative acknowledgement (NACK) for a third CBG transmitted by a source; and
relaying the NACK to the source.

3. The method of claim 1, wherein:
the signaling of the successful decoding of the first CBG comprises transmitting a first Zadoff-Chu sequence in a Physical Sidelink Feedback Channel (PSFCH), and
the signaling of the unsuccessful decoding of the second CBG comprises transmitting a second Zadoff-Chu sequence, different from the first Zadoff-Chu sequence, in the PSFCH.

4. The method of claim 1, wherein:
the signaling of the successful decoding of the first CBG comprises transmitting an indication of successful decoding as part of a payload of a Physical Sidelink Shared Channel (PSSCH), and
the signaling of the unsuccessful decoding of the second CBG comprises transmitting an indication of unsuccessful decoding as part of a payload of a PSSCH.

5. The method of claim 1, further comprising relaying, by the first UE, to a third UE, a third CBG received from a source and successfully decoded by the first UE, the relaying being based on a parameter selected from the group consisting of:
proximity of the third UE to the first UE;
received signal strength, at the first UE, from the source;
received signal strength, at the first UE, from the third UE;
successful decoding of the third CBG, by the first UE;
receipt, by the first UE, of a previously relayed copy of the third CBG;
a type of the first UE;
a power level of a first UE;
receipt, by the first UE, of a relaying request from the third UE;
a priority of the third CBG; and
combinations thereof.

6. The method of claim 5, wherein the relaying, by the first UE, to the third UE, of the third CBG, is based on receipt, by the first UE, of a relaying request from the third UE.

7. The method of claim 6, wherein the relaying request is carried in a Sidelink Control Information (SCI).

8. The method of claim 6, wherein the relaying request is a Zadoff-Chu sequence transmitted in a designated resource of a Physical Sidelink Feedback Channel, the designated resource having been configured through Radio Resource Control signaling from a network node for use to signal a retransmission request.

9. The method of claim 8, wherein the transmission in the designated resource signals that any UE receiving the relaying request is requested to perform relaying.

10. The method of claim 8, wherein the transmission in the designated resource signals that any UE receiving the relaying request, that has a measured signal strength above a threshold strength, is requested to perform relaying.

11. The method of claim 5, further comprising indicating, by the first UE, to the third UE, that the third CBG is a relayed CBG.

12. The method of claim 11, wherein the indicating comprises setting a bit in a Sidelink Control Information (SCI) or in a Media Access Control (MAC) Control Element (CE).

13. The method of claim 11, wherein the indicating comprises associating, with the third CBG:
a Hybrid Automatic Repeat Request (HARQ) process identifier,
a source identifier, and
a destination identifier, wherein
the HARQ process identifier is a HARQ process identifier associated by the source with a second Transport Block, including the third CBG,
the source identifier is an identifier of the source, and
the destination identifier is an identifier of the third UE.

14. The method of claim 5, further comprising signaling, by the first UE, to the source, an acknowledgement (ACK) of a successful receipt and decoding of the third CBG by the first UE.

15. The method of claim 5, further comprising:
relaying, by the first UE, to the source, a negative acknowledgement (NACK) received by the first UE from the third UE, the NACK indicating an unsuccessful attempt, by the third UE, to decode the third CBG, the relayed NACK being sent by the first UE in the same resource as a NACK sent to the source by the third UE; or
relaying, by the first UE, to the source, an acknowledgement (ACK) received by the first UE from the third UE, the ACK indicating successful decoding, by the third UE, of a fourth CBG received from the source by the third UE, the relayed ACK being sent by the first UE in the same resource as an ACK sent to the source by the third UE.

16. A method, comprising:
receiving, by a first User Equipment (UE), a plurality of Code Block Groups (CBGs) from a source;
receiving, by the first UE, from a second UE:
an acknowledgement for a first CBG of the CBGs, and
a negative acknowledgement for a second CBG of the CBGs;
transmitting, by the first UE, to the second UE, the second CBG; and
not transmitting, by the first UE, to the second UE, the first CBG.

17. The method of claim 16, further comprising relaying the negative acknowledgement to the source.

18. The method of claim 16, wherein:
the receiving of the acknowledgement comprises receiving a first Zadoff-Chu sequence in a Physical Sidelink Feedback Channel (PSFCH), and
the receiving of the negative acknowledgement comprises receiving a second Zadoff-Chu sequence, different from the first Zadoff-Chu sequence, in a PSFCH.

19. The method of claim 16, wherein:
the receiving of the acknowledgement comprises receiving the acknowledgement as part of a payload of a Physical Sidelink Shared Channel (PSSCH), and the receiving of the negative acknowledgement comprises receiving the negative acknowledgement as part of a payload of a PSSCH.

20. A method, comprising:
receiving, by a first User Equipment (UE), an acknowledgement (ACK) or a negative acknowledgement (NACK), from a second UE, for a first Transport Block sent to the second UE by a source;
relaying, by the first UE, the ACK or the NACK to the source; and
relaying, by the first UE, a retransmission of the first Transport Block to the second UE.

21. The method of claim 20, further comprising:
receiving, from the source, by the first UE, a second Transport Block including a Media Access Control (MAC) header; and
relaying a portion of the second Transport Block to the second UE without decoding a MAC header of the second Transport Block.
